(19) United States
(12) Patent Application Publication
(10) Pub. No.: US 2019/0184907 A1
(43) Pub. Date: Jun. 20, 2019

(54) Mounting Apparatus for Portable Electronic Devices

(71) Applicant: TRAUB BROTHERS, LLC, Fulton, MD (US)

(72) Inventors: Noah Weintraub, Fulton, MD (US); Joshua Weintraub, Fulton, MD (US); Norman Barrigas, Bronxville, NY (US)

(73) Assignee: TRAUB BROTHERS, LLC, Fulton, MD (US)

(21) Appl. No.: 15/577,110

(22) PCT Filed: Jun. 9, 2016
(86) PCT No.: PCT/US16/36665

§ 371 Date: Nov. 27, 2017

Related U.S. Application Data
(60) Provisional application No. 62/180,132, filed on Jun. 16, 2015.

(51) Int. Cl. B60R 11/02; B60R 11/00

(52) U.S. Cl. CPC B60R 11/02; B60R 2011/0071; B60R 2011/0007; B60R 11/00

(57) ABSTRACT

Apparatuses for associating a portable electronic device with a cup holder are provided. The apparatuses may be formed from wire and/or make use of a leaf spring design and retain association with the portable electronic device through clamping and retain association with a cup holder through the use of a resiliently deformable element that can be deformed to a size smaller than the cup holder and when released, can push up against the walls of the cup holder with sufficient force to retain association therewith. In some embodiments, when the apparatus is used in a cup holder, the cup holder remains available to receive cups or other objects.

### CROSS-REFERENCE TO RELATED APPLICATIONS

This application is a national stage (section 371) of International patent application PCT/US2016/036665, filed Jun. 9, 2016, which claims the benefit of the filing date of U.S. Provisional Application Ser. No. 62/180,132, filed Jun. 16, 2015, the entire disclosures of which are incorporated by reference as if set forth fully herein.

### FIELD OF THE INVENTION

The present invention relates to the field of apparatuses for associating portable electronic devices with cup holders.

### BACKGROUND OF THE INVENTION

Portable electronic devices, such as smart phones and tablets are becoming ubiquitous, and most users of these devices prefer to have their devices in close proximity at all times. One of the locations in which users of portable electronic devices like to keep their devices in close proximity is within motor vehicles such as automobiles.

In many jurisdictions, the use of a mobile device while operating a motor vehicle in any mode other than hands free is prohibited. Consequently, in order to permit persons to be able to use their cellular telephones while operating their motor vehicles, inventors have begun to propose ideas for reversibly associating cellular telephones with structures in motor vehicles so that as a motor vehicle moves, the cellular telephone stays in the same place relative to the user, and the user can operate the device without the use of his or her hands.

For example, a few vehicle manufacturers now build portable telephone docking apparatuses into the interior cabins of their automobiles. The location may, for example, be in a console. However, the public has not yet widely embraced any of these types of solutions, and consequently, manufactures of most vehicles do not equip their vehicles with these features.

Alternative solutions that inventors have proposed include various types of mounting devices. However, many of these devices require some permanent or semi-permanent attachment to the floorboard, dashboard, or other structural component of the vehicle. Most drivers do not have either the skills required or the inclination to install such attachments, particularly because doing so can be expensive.

Other solutions include mounting a structure to a dashboard or a windshield through suction or an adhesive. These structures are designed so that through one or more of friction, adhesion, and magnetic forces, the cellular telephone remains in place. Unfortunately, these solutions are not optimally effective at keeping the cellular telephone in place and often cause it to be located at a position that is an unacceptable distance from the driver.

Another alternative solution that has been proposed is to associate the cellular telephone with the center counsel at, for example, the cup holder. However, the devices that have been proposed to date, see for example U.S. Pat. No. 6,246,766, Portable Telephone Mounting Base, issued Jun. 12, 2001, are unacceptably cumbersome and/or undesirably restrict the ability of the user to access the cup holder for the cup holder's intended purpose while retaining the cellular telephone at a desired location. The present invention is directed to providing alternative solutions to the challenge of how to mount a portable electronic device.

### SUMMARY OF THE INVENTION

The present invention provides devices, which also may be referred to as apparatuses, for allowing persons to associate their portable electronic devices with cup holders. The portable electronic devices may, for example, be cellular telephones or tablets. The cup holders may, for example, be located within motor vehicles such as automobiles, boats, airplanes, or trains, or the cup holders may, for example, be located within or be associated with a structure such as a chair, a couch or a table that is not part of or within a motor vehicle.

According to a first embodiment, the present invention is directed to an apparatus for associating a portable electronic device with a cup holder, the apparatus comprising: (a) a clamp, wherein the clamp comprises (i) a first side grip, and (ii) a second side grip, wherein the first side grip and the second side grip are capable of clamping a portable electronic device that is located between the first side grip and the second side grip; (b) a cup holder retaining element, wherein the cup holder retaining element comprises a wire that forms either (i) one contiguous leg that has an arcuate region that spans at least 180 degrees and is less than 5 centimeters high and less than 2 centimeters wide, or (ii) a pair of legs that comprises a first leg that has a first arcuate region and a second leg that has a second arcuate region, wherein a portion of the first arcuate region is located 180 degrees from a portion of the second arcuate region, wherein each arcuate region is less than 5 centimeters high and less than 2 centimeters wide, wherein the cup holder retaining element is configured to retain association with a cup holder by mechanical force; and (c) a connector, wherein the connector is located between the clamp and the cup holder retaining element.

According to a second embodiment, the present invention is directed to a wire device for associating a portable electronic device with a cup holder, wherein the wire device comprises wire that forms: (a) a first region that forms a clamp, wherein the clamp is capable of engaging a portable electronic device; (b) a second region, wherein the second region forms a cradle for the portable electronic device; and (c) a third region, wherein the third region is either (i) in the form of an arc that has a first configuration and a second configuration, and the arc is capable of being deformed from the first configuration to the second configuration upon the application of force and is capable of being reformed to the first configuration upon release of the force, or (ii) in the form of a first arc leg and a second arc leg, wherein first arc leg and the second arc leg are capable of having a first configuration and a second configuration and are capable of being deformed from the first configuration to the second configuration upon the application of force and are capable of being reformed to the first configuration upon release of the force, wherein the third region is capable of retaining association with a cup holder by mechanical force.

According to a third embodiment, the present invention provides an apparatus for associating a portable electronic device with a cup holder, wherein the apparatus comprises: (a) a clamp, wherein the clamp is configured to retain association with a portable electronic device; and (b) a cup holder retaining element, wherein the cup holder retaining element comprises a base and a plurality of side bracing elements, wherein each of the plurality of side bracing elements is capable of existing in a first state and a second state, wherein in the first state each side bracing element forms a first angle with the base and in the second state each side bracing element forms a second angle with the base, wherein the second angle is at least 90 degrees, the second angle is smaller than the first angle, and first angle is up to 180, wherein the clamp is connected either directly or through a connector to the cup holder retaining element. The cup holder retaining elements is configured to retain association with a cup holder by mechanical forces as the side bracing element push against the side of the cup holder when the side bracing elements are in the second state. As persons of ordinary skill in the art will recognize, the limit of the second state (i.e., the smallest second angle) is defined by the structure and composition of the apparatus itself, but when in use the second angle is defined by the walls of the cup holder into which the apparatus is inserted. Preferably, the side bracing elements are made from a resiliently deformable material that may upon the exertion of force reversibly move between the first state and the second state.

According to a fourth embodiment, the present invention provides an apparatus for associating a portable electronic device with a cup holder, wherein the apparatus comprises: (a) a cup holder retaining element, wherein the cup holder retaining element comprise a base and a plurality of side bracing elements, wherein each of the plurality of side bracing elements is capable of existing in a first state and a second state, wherein in the first state each side bracing element forms a first angle with the base and in the second state each side bracing element forms a second angle with the base, wherein the second angle is at least 90 degrees, the second angle is smaller than the first angle, and first angle is up to 180, and (b) an elongated element, wherein the elongated element comprises an adapter, wherein the adapter is configured to associate with a connector or clamp and the elongated element is connected to the base of the cup holder retaining element.

Through the use of various apparatuses and devices of the present invention, one may efficiently and effectively retain association of a portable electronic device with a cup holder. When the apparatus or device of the present invention is located within a motor vehicle, it will remain securely in place and thus in a location of which a driver or passenger will be aware, regardless of whether the motor vehicle is stationary or in motion. Furthermore, due to the construction of various embodiments of the present invention, some or all of the functionalities of the portable electronic device may be accessed without removing the portable electronic device from the apparatus or device of the present invention. Thus, in some embodiments, access is not blocked by any physical structures. Additionally, the apparatus or device may be designed such that a user retains his or her ability to use the cup holder for its intended purpose; i.e., holding a cup.

When using the apparatus or device of the present invention, one may first insert the portable electronic device within the structure of the present invention by opening the clamp or first region and allowing it to clamp the portable electronic device in a secure position. Then when using embodiments in which the cup holder retaining element comprises arcuate regions, one may exert a force on the cup holder retaining element to deform the arcuate region or regions, insert the cup holder retaining element within a cup holder and release the force. Alternatively, when using these apparatuses or devices, one may initially exert a force on the cup holder retaining element to deform the arcuate region or regions, insert the cup holder retaining element or third region within a cup holder and release the force. Then, one may insert the portable electronic device within the structure of the present invention by opening the clamp or first region and allowing it to clamp the portable electronic device in a secure position. When using embodiments in which the cup holder retaining element is in the form of a base and a plurality of side bracing elements, one may either: (1) first insert the apparatus into a cup holder, whereby as the apparatus is pushed downward, the sides of the cup holder, which will have an angle smaller than the first angle and up to limit of the second angle, will force the side bracing elements to be at a second angle, and then insert the portable electronic device into the clamp; or (2) first insert the portable electronic device into the clamp and then insert the apparatus into the cup holder.

### BRIEF DESCRIPTION OF THE FIGURES

FIG. 1 is a representation of an apparatus of the present invention.

FIG. 2 is a representation of another apparatus of the present invention.

FIG. 3 is a representation of a wire device of the present invention as inserted into a cup holder and as holding a cellular telephone.

FIG. 4 is a representation of the present invention that illustrates a leaf design with a universal adapter and with a clamp.

FIG. 5 is a representation of a leaf design of the present invention that illustrates how a cup may exist within the cup holder when a leaf design is used.

### DETAILED DESCRIPTION OF THE INVENTION

Reference will now be made in detail to various embodiments of the present invention, examples of which are illustrated in the accompanying figures. In the following detailed description, numerous specific details are set forth in order to provide a thorough understanding of the present invention. However, unless otherwise indicated or implicit from context, the details are intended to be examples and should not be deemed to limit the scope of the invention in any way.

Additionally, headings are used for the convenience of the reader and are not intended to limit the scope of any of the embodiments of the present invention or to suggest that any feature that is discussed within one embodiment is or is not applicable in connection with another embodiment.

According to a first embodiment, the present invention is directed to an apparatus for associating a portable electronic device with a cup holder. As used herein, the term “apparatus” refers to a device that is constructed or designed to retain association with one or more other items or devices. The association may, for example, be retained through mechanical forces. Mechanical forces include, but are not limited to, clamping forces and forces that are generated by impeding the expansion of resiliently deformable structures or structures that, in the absence of being restricted in movement by another structure, would expand to a larger size.

As persons of ordinary skill in the art know, cup holders are typically cylindrical or funnel-shaped with a base and a depth and have a uniform or substantially uniform radius at any given depth. Thus, they are configured as receptacles for cups. For example, a cup holder may have a depth, which also may be referred to as a height, of 5 centimeters to 20 centimeters or 8 centimeters to 15 centimeters. When in the form of a cylinder, which typically will have a closed base and open upper end, there may, for example, be uniform radius of 2 centimeters to 8 centimeters or 4 centimeters to 6 centimeters. When in the form of a funnel, which typically will have a closed base and open upper end, there may, for example, be a uniform radius at the lower end (the base) of 2 centimeters to 4 centimeters and a uniform radius at the upper end of 3 centimeters to 8 centimeters.

Cup holders may, for example, comprise, consist essentially of or consist of plastic, rubber, metal, a metal alloy or a combination thereof. As persons of ordinary skill in art know, cup holders may, for example, be found in consoles of motor vehicles as well as in the arms of stationary seats such as chairs and couches in a person's home or in public spaces, such as at parks, at movie theaters and in stadiums.

Portable Electronic Device

The portable electronic device is any electronic device that is sufficiently light in weight and sufficiently small in size so as to be readily and easily transported by a person. Examples of dimensions of portable electronic devices for which the apparatuses of the present invention may in some embodiments be configured include but are not limited to those portable electronic devices of a height of 10 centimeters to 20 centimeters or 12 centimeters to 16 centimeters; a width from side to side of 4 centimeters to 10 centimeters or 5 centimeters to 8 centimeters and a depth from front to back of 0.4 centimeters to 1.2 centimeters or 0.5 centimeters to 1.0 centimeters. As persons of ordinary skill in the art will recognize, the aforementioned lengths and widths suggest that the portable electronic device is held in a portrait orientation. In some embodiments, the apparatuses are configured to hold the devices only in their portrait orientations. In other embodiments, the apparatuses are configured to hold the devices only in their landscape orientations in which cases the ranges of the width and height are reversed, and in still other embodiments, the apparatuses are configured to hold the devices in both their portrait and landscape orientations. Examples of weights of portable electronic devices for which the apparatuses of the present invention may be configured are from 50 grams to 500 grams or 100 grams to 250 grams.

By way of non-limiting examples, a portable electronic device may be a cellular telephone or a tablet or a digital reading, recording or audio playing device. Commercially known portable electronic devices include, but are not limited to, the Samsung Galaxy Tab®, the Google Nexus devices, the Amazon Kindle®, the Kindle Fire®, the Apple iPhone®, the Apple iPad®, the Microsoft Surface®, and the Palm Pre™.

Apparatuses

In some embodiments, the apparatuses are formed exclusively or predominantly from wire. The wire may comprise, consist essentially of or consist of metal, a metal alloy, plastic, a polymer, rubber, e.g., a silicone based rubber, or combinations thereof. In one embodiment, the wire is in the form of a metal core, e.g., steel and has rubber, plastic, or a silicone based material or a combination thereof as an outer layer. Alternatively, the wire may be galvanized steel. In other embodiments, some or all of the apparatuses are not formed from wire and instead are formed from one or more of sheets of metal and/or metal alloys, molded plastics and/or other polymer and elastic materials such as a silicone based rubber.

When using wire, the wire itself may, in some embodiments, be 1 millimeter to 2 centimeters thick or 5 millimeters to 1 centimeter thick at its widest point. The wire may have uniform regular or irregular cross-section throughout the apparatus. In some embodiments, there are regions of uniform round cross-sections of 1 millimeter to 2 centimeters thick or 5 millimeters to 1 centimeter and one or more regions that are thicker and/or flatter than those regions.

Preferably, the wire is sufficiently resilient to hold a particular form, but also sufficiently flexible so that should a manufacturer or user wish to change the form of part of some of the apparatus, he or she could do so without the assistance of tools, i.e., he or she would be able to bend or to stretch it manually.

In some embodiments, the apparatus is formed from a single piece of wire that is put into the desired configuration. Thus, the apparatus may, for example, contain 30 centimeters to 300 centimeters of wire or 50 centimeters to 250 centimeters of wire or 100 centimeters to 200 centimeters of wire. The wire may be manipulated to the desired configuration through the use of, for example, wire bending pliers and/or automated devices for bending and configuring wires.

In some embodiments, the apparatus is configured so as to allow a user to access the cup holder by, for example placing a cup within it, while the portable electronic device is contained within the apparatus. In some embodiments, the apparatus is constructed of sufficiently strong material and in a configuration such that when it houses the portable electronic device, the center of gravity is within a connector.

In some embodiments, the apparatus contains three regions: a clamp, a connector and a cup holder retaining element. For ease of explanation, each of these may be referred to as its own structure. However, as persons of ordinary skill in the art will recognize, they may be formed from distinct structures or be regions within the same structure. These portions of the apparatus may be formed by configuring different regions of the same contiguous piece of wire or they may be formed by first configuring two or more wires and then affixing the regions together, through for example, soldering or tape, or they may be formed from a combination of wire and other materials, such as plastic or rubber. Additionally, the gross configuration of the apparatus may be such that all parts of a region or structure element are contiguous, or within any one region or structural element, there are parts that are not contiguous.

In other embodiments, the apparatus contains two regions or if formed from two structures: a clamp and a cup holder retaining element, wherein the cup holder retaining element comprises a base and side retaining elements. In these embodiments, optionally there is a connector that is in the form of a connector that is described in connection with other embodiments.

Clamp

The clamp is what associates the apparatus with the portable electronic device, and in some embodiments, the clamp comprises two or more side grips. The side grips may be in any of a number of configurations, provided that the side grips allow the clamp to retain association with the portable electronic device. For example, the side grips may be in the form of bends in wire, and alternatively or additionally, the side grips may comprise or form grooves in which the portable electronic device may sit. Further in some embodiments, the clamp is in the form of a pair of arms, and each arm contains one or a plurality of side grips and/or grooves. A side grip is a structure that contains a surface that, when in use, aligns with a side of the portable electronic device. A groove is a place in an arm in which an edge between a side and rear face of a portable electronic device may sit.

When there are two side grips, the two side grips may be referred to as a first side grip and a second side grip or a left side grip and a right side grip. The side grips are the parts of the apparatus that touch the opposite, e.g., left and right sides of the portable electronic device. In addition to touching the sides of the portable electronic device, the side grips may touch portions of the front and/or rear of the portable electronic device. Thus, the first side grip and the second side grip are capable of clamping a portable electronic device that is located between the first side grip and the second side grip.

As noted above, the clamp may also or alternatively comprise grooves, which are optionally located within the arms, e.g., within or near the side grips, if present. Thus, in one embodiment, the clamp comprises a first left side groove and a first right side groove on the left and right arms respectively, wherein the first left side groove and the first right side groove are configured to receive a portion of a portable electronic device of a first width, and the clamp comprises a second left side groove and a second right side groove on the left and right arms respectively, wherein the second left side groove and the second right side groove are configured to receive a portion of a portable electronic device of a second width. Optionally, the clamp further comprises a third left side groove and a third right side groove, wherein the third right side groove and the third left side groove are configured to receive a portable electronic device of a third width, wherein the first width, the second width and the third width are different from one another.

In some embodiments, the side grips are configured so that they have no sharps edges. Thus, they are designed so that the grips will not harm either a user of the apparatus or the portable electronic device itself. The side grips are optionally smooth and/or flat, and in some embodiments are coated partially or completely with rubber. Preferably, the left side grip and the right side grip, when in use, will be located at the same relative height along the portable electronic device.

Within the scope of the present invention, are apparatuses that have more than two side grips. For example, there may be four side grips, and when there are four side grips, there may be a first left side grip and a second left side grip, and there may be a first right side grip and a second right side grip. In some embodiments, there may be six side grips, and when there are six side grips, there may be a first left side grip, a second left side grip and a third left side grip, and there may be first right side grip, a second right side grip and a third right side grip. In still other embodiments, there may be eight side grips, and when there are eight side grips, there may be a first left side grip, a second left side grip, a third left side grip and a fourth left side grip, and there may be first right side grip, a second right side grip, a third right side grip and a fourth right side grip. If there is a plurality of side grips within each arm when the apparatus is in use, preferably only one pair of side grips contacts the portable electronic device.

Regardless of the number of side grips, preferably none of them cover any input or output structures of the portable electronic device, or if they cover any input or output structure of the portable electronic device, they do so only to the extent that they do not undesirably impede usage of the features of the input or output structures. Thus, when the portable electronic device is a cellular telephone that contains buttons for activation, the buttons for activation are unobscured by the apparatus. Further, preferably, any touchscreen, speaker, microphone, camera or graphic user interface of the portable electronic device is not obscured or is not undesirably obscured by any structure of the apparatus.

The apparatus may be constructed such that when no device is located within the clamp, each left side grip is a first distance from a right side grip. When a device is located between the left side grip(s) and the right side grip(s), each left side grip is a second distance from a right side grip, wherein the second distance is larger than the first distance. This distance may correspond to the width of a portable electronic device.

As persons of ordinary skill in the art will recognize, different portable electronic devices have different widths, and the apparatus is preferably capable of housing portable electronic devices of a plurality of different widths. Thus, the apparatus is designed with a fixed first distance and a maximum second distance, which is the maximum distance apart that a left side grip and correspondence right side grip can be under normal operation of the apparatus. However, when the apparatus is in use, different portable electronic devices will cause the clamp to be opened to different degrees. If the clamp contains grooves, it may contain a plurality of left and right side grooves, e.g., two to six left side grooves and two to six right side grooves. When there are three or more side grooves, they may be spaced apart at equal or unequal distances.

The ability of the clamp to retain the portable electronic device may be rooted in the composition of the material used and/or its configuration. Tension within the wire will exert a force that seeks to bring the left grip and the right grip back to the resting state, which correspondence to when they are the first distance apart. When a portable electronic device is present between the arms of the clamp, the portable electronic device will prevent the arms from coming together any closer than the width of the portable electronic device.

In some embodiments, there is a coil along the portion of the apparatus that connects the first side grip and the second side grip or when there are four or more side grips, the left side grip that corresponds to the configuration for the smaller or smallest portable electronic device and the right side grip that corresponds to the configuration for the smaller or smallest portable electronic device. The coil may be formed from the same material as the side grips and is within the clamp. The coil may, for example, be configured as two to eight or four to six overlapping or stacked rings, and impart tension to the clamp, i.e., supply or supplement the force of the clamp that defines the dimension between the right and the left arms and that causes the corresponding space to decrease in the absence of an opposing force or structure. Alternatively or additionally, the coil may cause or supplement the force that the cup holder retaining element exerts on the cup holder.

Additionally or alternatively, within the clamp, there may be one, two or more springs. The spring or springs may be oriented to impart resistance to opening of the clamp. When there is one spring, each end may be located between the coil and side grip (or between the coil and all side grips in and arm when there is a plurality of side grips). Thus, the spring connects the left and right sides of the clamp. Alternatively, each end of the spring connects to an arm of the clamp at a location such that the left side grip (or all left side grips when there is a plurality of side grips on an arm) and the right side grip (or all right side grips when there is a plurality of side grips on an arm) are located between the corresponding end of the spring and the coil. In still another embodiment, both of the aforementioned springs are present. Examples of materials from which the springs may be constructed include, but are not limited to, metals, rubber e.g., rubber tubing, other stretchable materials, and combinations thereof.

In order to open the clamp, a user may pull the arms apart with his or her hands. After the user opens the clamp, he or she may insert the portable electronic device and then release the arms.

Further, in some embodiments, the clamp comprises one or more handles that are capable of altering the distance between the first side grip and the second side grip. When a handle is present, the user may squeeze the handle in order to open the clamp. After the user opens the clamp, he or she may insert the portable electronic device and then release the handles.

As noted above, the clamp may be formed from a piece of wire that is contiguous with the other elements of the apparatus. Alternatively, it may be formed from a different piece of wire or other materials or a combination thereof and affixed to the other parts of the apparatus.

As persons of ordinary skill in the art will recognize, a clamp need not be made exclusively of wire. For example, it may comprise, consist essentially of or consist of side elements that are connected by a spring and a flat piece on which the cellular telephone may rest. Furthermore, rather than being in the form of wire, the clamp may comprises, consist essentially of, or consist of one or more of metal, a metal alloy, an elastic material, or plastic or a combination thereof that are not in the form of wire structures. Thus, they may be in the form of molded materials and/or metal parts made from sheets of metals or other processes that are known to persons of ordinary skill in the art. In these embodiments, there are clamping elements that may be opened and closed to retain the portable electronic device in place and optionally a back plate on which the portable electronic device may rest, wherein the back plate exist either at a fixed angle or at an angle that may be adjusted and then held in place. These embodiments may, for example, be advantageous with the leaf design described below.

Cup Holder Retaining Element

The cup holder retaining element is the part of the apparatus that permits the apparatus to retain association with a cup holder. It is configured to retain association with a cup holder by mechanical force. However, whereas the clamp works by exerting a force inward, thereby forcing the side grips together, the cup holder retaining element accomplishes its function by exerting a force outward again the walls of the cup holder.

In various embodiments, the cup holder retaining element is capable of being deformed radially inward to facilitate insertion into the cup holder. In some embodiments, the cup holder retaining element has a first arc radius and a second arc radius, wherein the first arc radius is larger than the second arc radius and the cup holder retaining element has the first arc radius when no external force is applied to the cup holder retaining element, and the cup holder retaining element has the second arc radius when an external force is applied to the cup holder retaining element. The second arc radius may be regular or irregular, such that within the scope of the present invention, there are apparatuses in which the arc becomes deformed and is not of uniform curvature when the deforming force is applied to the cup holder retaining element. In some embodiments, the first arc radius is from 2 centimeters to 6 centimeters in length, and may be reduced by 20% to 80% upon application of a mechanical force. The arc radius is defined as the distance from the arc to the point that is equidistant from all of the points on the arc.

When the apparatus is in use, the clamp is the upper part of the apparatus, and the cup holder retaining element is the lower part of the apparatus. The cup holder retaining element may be in the form of one leg or more than one leg. In one embodiment, it comprises, consists essentially of or consists of one contiguous leg that has an arcuate region that spans at least 180 degrees, e.g., 180 degrees to 360 degrees; 210 degrees to 330 degrees; or 260 degrees to 290 degrees and is less than 5 centimeters high; less than 4 centimeters high; less than 3 centimeters high; or less than 2 centimeters high and less than 2 centimeters wide; less than 1 centimeter wide; or less than 0.5 centimeters wide. In some embodiments, the arcuate region of the one contiguous leg may span between 180 and 345 degrees or between 210 and 270 degrees.

When there is one leg, the single leg may, for example, have a horizontal element that, when in association with the cup holder, runs along an inner portion of the cup holder and a vertical element that connects to the connector. Preferably, the longest dimension of the horizontal element forms an angle of less than 30 degrees, less than 20 degrees, less than 10 degrees, less than 5 degrees, or less than 2 degrees with the horizontal plane or is parallel to the horizontal plane when the apparatus is in use. Preferably, the vertical element has a longest dimension that forms an angle of greater than 60 degrees, greater than 70 degrees, greater than 80 degrees, greater than 85 degrees or greater than 88 degrees with the horizontal plane or is perpendicular to the horizontal plane when the apparatus is in use.

The single leg may take any of a number of different forms and be of a number of different sizes. For example, the horizontal element may be in the form a regular or irregular elongated and arcuate wire loop, elongated and arcuate wire ellipse, elongated and arcuate wire rectangle or modified elongated and arcuate wire rectangle with rounded corners. The single leg of the horizontal element may, for example, have a height of 1 centimeter to 5 centimeters or 2 centimeters to 4 centimeters or 3 centimeters to 4 centimeters.

The single leg may, for example, be a material such as a wire, and form only the perimeter of a regular or irregular shape, or the single leg may be completely or partially solid such that there is material within the interior of the shape that forms a surface that will contact the wall of the cup holder. When partially or completely solid, the interior shape has an increased surface area relative to the hollow shape, which may, in some embodiments, increase the ability of the cup holder retaining element to cause association with the cup holder. When the shape has a contiguous surface area, and not merely a wire outline, one may refer to it as a blade.

The vertical element extends from the horizontal element to the connector. In some embodiments, the vertical element is 1 centimeter to 8 centimeters; 2 centimeters to 7 centimeters; or 3 centimeters to 5 centimeters high. The vertical element may, for example, be a single wire or a pair of wires that are parallel to each other. When there is a single leg and a single vertical element, the single vertical element may bisect the horizontal element or connect to the horizontal element at or near the half-way point of the upper edge or upper wire of the horizontal element. When there is a single leg and two or more vertical elements, the mid-way point between the plurality of vertical elements may bisect the horizontal element or connect to the horizontal element at or near the half-way point of the upper edge or upper wire of the horizontal element.

When the horizontal element is a single leg, the outer edge may be contiguous. Thus, if the apparatus is made from a single wire, the termini may, for example, reside in the connector or in the clamp.

In a different embodiment, the apparatus comprises, consists essentially of or consists of a pair of legs that comprise a first arcuate region and a second arcuate region, wherein a portion of the first arcuate region is located 180 degrees from a portion of the second arcuate region, wherein each arcuate region is less than 5 centimeters high and less than 2 centimeters wide.

By way of example, the first arcuate region may span between 60 and 180 degrees or between 90 and 150 degrees, and the second arcuate region may span between 60 and 180 degrees or between 90 and 150 degrees. When there are two legs, each leg, which is a horizontal element, may connect to the same vertical element or to different vertical element, e.g., a first vertical element connected to a first arcuate region of a first leg and a second vertical element connected to a second arcuate region of a second leg. In some embodiments, each vertical element is 1 centimeter to 8 centimeters; 2 centimeters to 7 centimeters; or 3 centimeters to 5 centimeters high.

In some embodiments, each leg is a mirror image of the other leg. In these cases, the vertical elements may connect at symmetrical locations within or along the horizontal elements, and for example, do so at less than 2 centimeters; less than 1 centimeter; or less than 0.5 centimeters apart as measured along the inner circumference along the cup holder. By placing the vertical element at symmetric locations, the center of gravity may be located between them.

In other embodiments, the horizontal element of each leg within the pair of legs is not a mirror image of the other leg. When the two legs are not mirror images, then the vertical elements may be located and configured so as to stabilize the center of gravity of the apparatus when the portable electronic device is housed with the apparatus.

In some embodiments, the cup holder retaining element further comprises a stability region, wherein there is more surface area over the stability region than there is over the same length of the connector. The stability region may be coated with a material that increases friction with a cup holder.

An alternative design for the cup holder retaining element is a leaf spring design. In this design, the cup holder retaining element comprises: (i) a base; and (ii) a plurality of side bracing elements, wherein the side bracing elements extend outward from the base. Either of both of these elements may be coated on a side with a material that increases friction with a cup holder.

The base of the leaf spring design may, for example, be flat and circular or substantially circular or another regular or irregular shape. In some embodiments the base of the leaf spring design cup holder retaining element is the same shape as the base of the cup holder into which it is to be inserted. Within the scope of the present invention are bases of leaf spring designs that are solid, e.g., that form a flat disc, as well as those that are not solid, i.e., there are open spaces. Preferably, if the base is not completely solid, the base contains material that forms a uniform perimeter, e.g., a rim.

The side bracing elements extend from the base, but when in use in a cup holder they are not in the same plane as the base. In some embodiments, there are 2-12 or 3-10 or 4-9 or 5-8 or 6-7 side bracing elements. Each of the side bracing elements may, for example, be rectangular or another regular shape or each may be an irregular shape. Within any one device, they may all be the same shape or two or more or each may have different shapes. Additionally, in some embodiments, they are evenly spaced around the base.

The side bracing elements are designed to stabilize the apparatus and to cause an association of the apparatus with the cup holder. They are also designed so as to allow for the cup holder to be used as a receptacle. For example, they may be rectangular in shape (optionally with rounded edges) and 2-12 cm or 4-10 cm or 6-8 cm in length. As persons of ordinary skill will recognize, the length is the dimension from the base of the cup holder to the side of the side bracing element distal to base. Preferably, the length is selected such that when within the cup holder the side bracing elements do not extend beyond the rim of the cup holder element. In some embodiments, when within the cup holder the side of each side bracing element that is distal to the base is 1-5 cm or 2-4 cm away from the rim of the cup holder.

In some embodiments, the side bracing elements are 0.5 to 6 centimeters wide or 1 to 3 centimeter wide.

In some embodiments, the side bracing elements are 1 millimeter to 2 centimeters thick or 5 millimeters to 1 centimeter thick. As persons of ordinary skill will recognize, the thickness is the dimension between the wall of the cup holder and the cup when the apparatus is in use and a cup is inserted in the cup holder.

The side bracing elements may exist in a plurality of states, e.g., in a first state and a second state. In the first state, the cup holder retaining element is not inserted in a cup holder and there is no force exerted on the exterior of the side bracing elements. In the second state, the cup holder retaining element is inserted in a cup holder and there is a force exerted on the exterior of the side bracing elements. Thus, the first state is a state of lowest energy.

In the first state, the side bracing elements may be within the same plane as the base, i.e., they are flat or in the first state they are not in the same plane as the base and form a first angle relative to the base. The first angle is an obtuse angle relative to the base, and if the side bracing elements are not in the same plane as the base, it is between 90 degrees and 180 degrees or between 110 degrees and 170 degrees or between 120 degrees and 160 degrees or between 130 degrees and 150 degrees.

In the second state, which corresponds to when the cup holder retaining element is within the cup holder, the side bracing elements form a second angle that is greater than or equal to 90 degrees and less than the first angle. In some embodiments, the first angle is 10 to 60 degrees or 20 to 50 degrees or 30 to 45 degrees larger than the second angle when in use for a particular cup holder. In some embodiments, the first angle is 10 to 60 degrees or 20 to 50 degrees or 30 to 45 degrees larger than the smallest possible second angle, which is defined by the composition and construction of the apparatus.

When using a leaf spring design, the side bracing elements and the base may be made of the same or different materials. By way of non-limiting examples, they may comprise, consist essentially or consist of metal, a metal oxide or combinations thereof. Regardless of the specific material that is selected, the side bracing elements should be capable of being moved from the first state to the second state and back multiple times without degradation of the materials. Thus, they may comprise, consist essentially or of consist of a resiliently deformable material and bend at or about the location at which they meet the base. This location may optionally be the same thickness as one or both of the side bracing elements and the base or it may be thinner Additionally, at this location, the cup holder retaining element may be made of the same material as the side bracing elements and/or the base so that the transition from the side bracing elements to the base is seamless.

Optionally, when using the leaf spring design, there is also an elongated element. The elongated element, like the side bracing elements, extends from the base. However, it is longer than the side bracing elements and it extends to at least the rim of the cup holder when the apparatus is inserted within the cup holder. In some embodiments, it is 6-30 cm or 10-20 cm in length. This elongated element may be the same thickness and width as the side bracing elements or it made by wider and/or thicker than the side bracing elements. The elongated element is the structure that connects the cup holder retaining element to other portions of the apparatus, e.g., a connector, if present or the clamp.

When there is an elongated element, the side bracing elements may be spaced evenly apart regardless of the placement of the elongated element or the even spacing may be designed to include the elongated element. Thus, if there are five side bracing elements and the elongated element, either: (i) each of the side bracing elements may be approximately 72 degrees from adjacent side bracing elements and the elongated element would be half-way between two side bracing elements; or (ii) each element is 60 degrees from an adjacent element, which for each side bracing element would be another side bracing element on at least one side and for two or them, the elongated element on the other side.

In some embodiments, the elongated element is made of the same material as the side bracing elements. In other embodiments, it is made of a more rigid material. Optionally, the elongated element may be thicker or the same size as the side bracing elements. Further, in some embodiments, the elongated element moves between a first state and a second state that are the same as the first state and the second state of the side bracing elements. In other embodiments, the elongated element moves between a different first state and/or a different second state than the side bracing elements. Thus, by way of a non-limiting example, the elongated element may, when in the second state have an angle of 90 degrees to 120 degrees relative to the base and in the first state have an angle of 100 degrees to 140 degrees. In some embodiments in which the elongated element moves from a different first state and/or a different second state than the second element, the first and second states of the elongated element are defined by the movement of the bracing elements and not the side walls of the cup holder.

Connector

The connector is located between the clamp and the cup holder retaining element. The connector, when present, may be designed so as to form a seat or cradle for the portable electronic device. The seat may be configured to situate the electronic device outside of any vertical space that defines or is coextensive with the cup holder or intrudes no more than 5 centimeters; no more than 3 centimeters; or no more than 1 centimeter into that space. Consequently, the apparatus will not prevent a user of the apparatus from accessing the cavity of the cup holder, and the user will be able to insert a cup or other instrument or device into the cup holder while the portable electronic device is in use.

Additionally, when the cellular telephone contains a port for docking, preferably the port for docking is unobscured by the connector or any other part of the apparatus.

In some embodiments, the connector is configured to rest on or near the lip of a cup holder through two or more bends or sets of bends in the connector. The lip is the location at the top of the cup holder, i.e., the highest height. When the cup holder is part of the console in a motor vehicle, the lip may transition to a flat or contoured, regular or irregular, horizontal surface. Thus, in one embodiment, a cradle touches the lip of the cup holder or is less than 2 centimeters; less than 1 centimeter; or less than 0.5 centimeters from the lip of the cup holder. In another embodiment, the connector also functions as a spacer and elevates the apparatus above the lip of the cup holder. For example, the connector may contain sufficient material to position the cradle portion between 2 centimeters and 60 centimeters; between 5 centimeters and 50 centimeters; between 10 centimeters and 40 centimeters; or between 20 centimeters and 30 centimeters above the lip of the cup holder. This spacer region may be rigid or flexible. Additionally, it may be a fixed length or it may be expandable by, for example, having telescoping members or other adjustable means, such as a reversibly locking extender in which a first element resides within a second element and either or both these elements may be move to extend the length of the spacer, upon release of a locking functionality and may be secured by tightening of the locking functionality. Examples of locking functionalities include key and lock structures, pins and holes, and screws and threads and combinations thereof. In some embodiments that contain an elongated element, this extension functionality may be part of the elongate element and/or part of a connector if present.

As noted above, the connector may be formed from a piece of wire that is contiguous with the wire that forms other elements of the apparatus. Alternatively, it may be formed from a different piece of wire or other material or a combination thereof and affixed to the other parts of the apparatus through, for example, taping or soldering.

Optionally, one may add weights to the connector to ensure that the center of gravity passes through it when the apparatus holds the portable electronic device.

The cradle that the connector forms may be at an angle, e.g., 30 degrees to 80 degrees relative to the horizontal plane; 40 degrees to 70 degrees relative to the horizontal plane; or 45 degrees to 60 degrees relative to the horizontal plane. The cradle may be fixed or flexible and oriented away from the cup holder, thereby allowing for better accessibility to the cup holder and acceptable viewing, which should only be done under safe conditions.

In some embodiments, there is no connector. For example, when using a leaf spring design, the elongated element might extend directly into a clamp.

Alternatively, the connector may be present in connection with a leaf spring design and be constructed to connect the base of the cup holder retaining element to the clamp.

Supplemental Retaining Element

In order to increase the forces that associate the apparatus with a cup holder, there may be one or more supplemental retaining elements. In embodiments that have a wire cup holder retaining element, these supplemental retaining elements may, for example, be part of the same wire as the cup holder retaining element and located between the cup holder retaining element and the connector. In some embodiments, the supplemental retaining element is smaller than the cup holder retaining element.

In other embodiments, it is the same size or larger than the cup holder retaining element.

When an apparatus contains a supplemental retaining element, preferably the supplemental retaining element possesses the same or similar mechanical properties that the cup holder retaining element also possesses. Additionally, it may be deformed by the same single force that the cup holder retaining element is deformed, and reformed in the same manner when the force is released. Furthermore, when a supplemental retaining element is used, preferably it is located between a vertical element of a cup holder retaining element and a connector.

In one embodiment, the apparatus further comprises a supplemental retaining element, wherein the supplemental retaining element has an arcuate region that spans at least 180 degrees and is less than 5 centimeters high and less than 2 centimeters wide or less than 1 centimeter wide or less than 0.5 centimeters wide, wherein the supplemental retaining element is configured to retain association with the cup holder by mechanical force. This supplemental retaining element may, for example, be 2 centimeters to 5 centimeters high or 3 centimeters to 4 centimeters high.

In another embodiment, the apparatus further comprises a pair of supplemental retaining elements that comprise a first supplemental retaining element and a second supplemental retaining element, wherein a portion of the first supplemental retaining element is located 180 degrees from a portion of the second supplemental retaining element, wherein each supplemental retaining element is less than 5 centimeters high and less than 2 centimeters wide, or less than 1 centimeter wide or less than 0.5 centimeters wide, wherein the supplemental retaining element is configured to retain association with the cup holder by mechanical force. This supplemental retaining element may, for example, be 2 centimeters to 5 centimeters high or 3 centimeters to 4 centimeters high. Each of these supplemental retaining elements may span between 60 and 180 degrees or between 90 and 150 degrees.

Wire Device

In another embodiment, the present invention provides a wire device for associating a portable electronic device with a cup holder. This wire device comprises three regions.

The first region forms a clamp, wherein the clamp is capable of engaging a portable electronic device. The clamp may comprise a first left side groove and a first right groove, wherein the first left side groove and the first right side groove are configured to receive a portion of the electronic device. In some embodiments, the clamp further comprises a second left side groove and a second right side groove, wherein the second left side groove and the second right side groove are each configured to receive a portion of an electronic device that is smaller than an electronic device that the first left side groove and the first right side groove are configured to receive. Alternatively or additionally, the clamp may comprise a right side grip and a left side grip, wherein the right side grip and the left side grip are each configured to receive a portion of the electronic device.

The second region forms a cradle for the portable electronic device. This cradle may, for example, form a bend or a plurality of bends on which the base of the portable electronic device may rest. Additionally, the cradle may be configured to rest on or near the lip of a cup holder.

The third region may be either: (i) in the form of an arc that has a first configuration and a second configuration, and the arc is capable of being deformed from the first configuration to the second configuration upon the application of force and is capable of being reformed to the first configuration upon release of the force, or (ii) in the form of a first arc leg and a second arc leg, wherein first arc leg and the second arc leg are capable of having a first configuration and a second configuration and are capable of being deformed from the first configuration to the second configuration upon the application of force and are capable of being reformed to the first configuration upon release of the force, wherein the third region is capable of retaining association with a cup holder by mechanical force. The third region, when in use, is located within a cup holder and abuts an interior surface of the cup holder. Thus, when in use there may also be a cup within the cup holder.

This wire device may comprise, consist essentially of or consist of metal, a metal alloy or a combination thereof. In some embodiments, the wire device further comprises rubber, plastic, silicone or a combination thereof as for example, a coating.

By way of a non-limiting example, the wire device may be configured to cradle a portable electronic device, and the portable electronic device may be a cellular telephone. Preferably, when the wire device is being used to mount a portable electronic device, the amount of available space within the cup holder is reduced by no more than 5%, 4%, 3%, 2%, 1%, 0.5%, 0.1% or 0.01%.

In some embodiments, each of the first region, the second region and the third region is formed from wire that is less than 2 centimeters thick.

Various embodiments of the present invention may be further understood by reference to the accompanying figures.

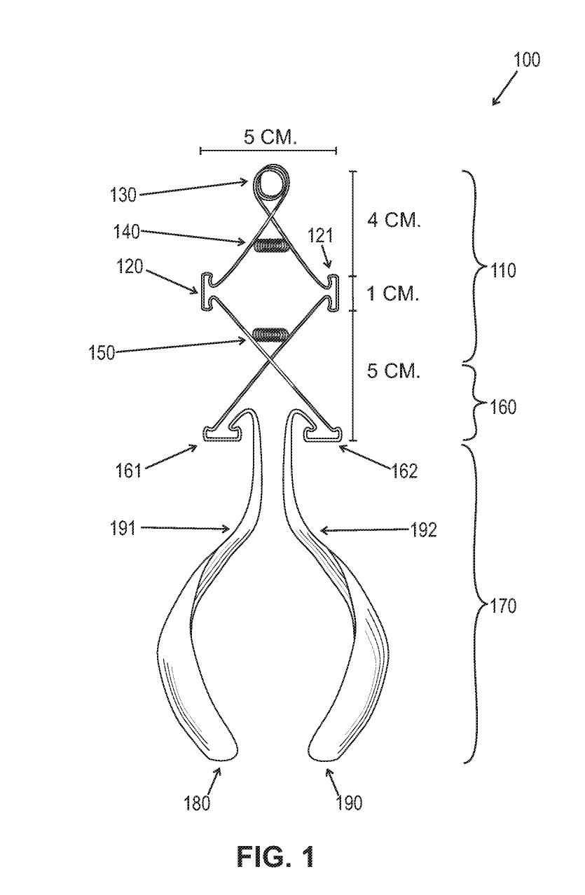

In FIG. 1, a wire device 100 of the present invention is shown. It is a metal wire that is coated with silicone or another rubber material. In the upper portion of the figure is the first region 110, which corresponds to a clamp. The clamp contains a right side grip 120 and a left side grip 121. When contracted, the distance between the left side grip and the right side grip is approximately 5 centimeters. Located between the right side grip and the left side grip is a coil 130 that imparts tension. As persons of ordinary skill in the art will recognize, in other embodiments the coil may alternatively be located within the second region or between the second region and the first region or between the second region and the third region. Additionally, in some embodiments, one may choose to have a plurality of coils that are positioned at different of the aforementioned locations. Also shown are two springs 140 and 150, which maintain the force on the apparatus to contract to the smallest distance between the left side grip and right side grip.

The second region 160 contains receiving elements 161 and 162, which are configured to form the base of a cradle for the portable electronic device. The third region 170 contains two legs 180 and 190. Within each leg is a tapered region 191 and 192 that transitions the wire to a thinner but fatter form that has more surface area. By having more surface area, the ability to create a force against a cup holder is over a larger area than if the wire had not been tapered.

In the embodiment shown in FIG. 1, the wire crosses twice, once within the first region and once between the first region and the second region. The ends of the wire are within each of the legs of the third region and may be rounded and/or covered with plastic and/or rubber to prevent scratching.

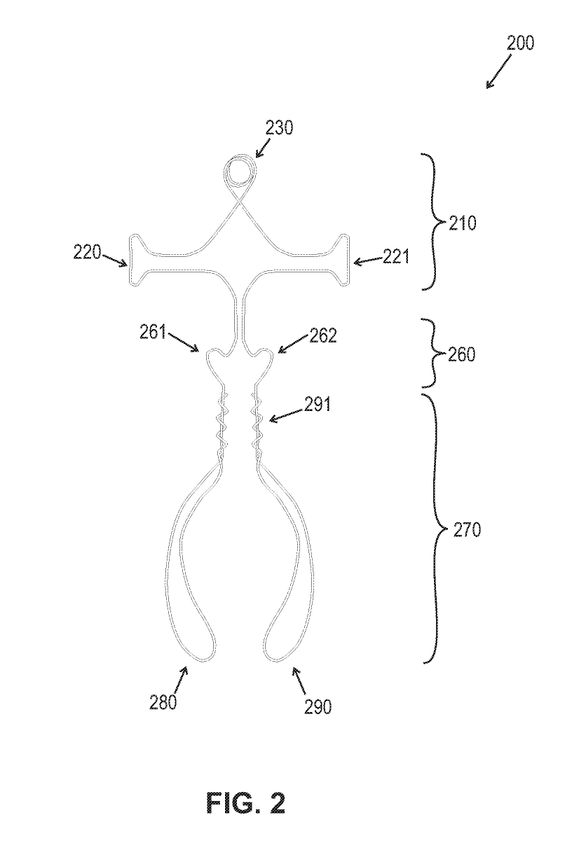

In FIG. 2 a different wire device 200 is shown. As with the device of FIG. 1, there is a first region 210, a second region 260, and a third region 270. Within the first region, there is a coil 230 for introducing tension, a left side grip 220 and a right side grip 221. Bends in the wire at the left and right side grips as shown allow for gripping of the portable electronic device. The wire device is able to hold a portable electronic device in place by flexing to grip it in a hugging motion.

Also present are the receiving elements 261 and 262 of the second region, which are configured to form the base of a cradle for the portable electronic device. One difference between the device as shown in FIG. 1 and the device as shown in FIG. 2 is that in FIG. 2 there is a crossing of the wire between the side grips and the coil, but nowhere else. Another difference is the absence of springs.

In the third region, there is a portion shown that may be squeezed 291 so as to deform the third region radially inward, thereby allowing for insertion into a cup holder. The third region of this figure shows two legs 280 and 290. These legs are of uniform thickness.

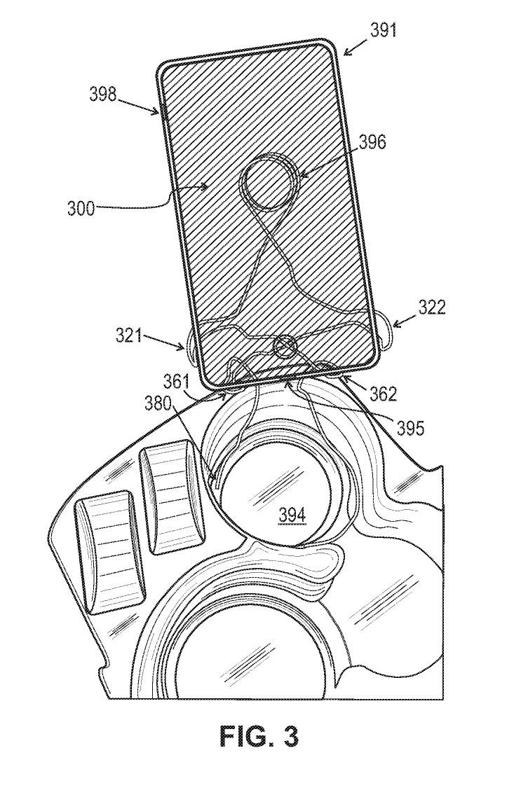

Turning to FIG. 3, one sees a representation of another embodiment of the present invention. In this embodiment, the wire device 300 is shown as inserted into a cup holder 394 and as holding a cellular telephone 391. Within the cup holder, there is a single leg 380 that has a horizontal region that forms an arcuate shape over less than 360 degrees of a cross-section of the cup holder. The wire may be of a uniform size throughout the wire device or thicker in certain regions such as in the cup holder retaining element region.

Within the cup holder retaining element region, the wire is thin enough that the cup holder may serve as a receptacle for a cup while the wire device is in use, i.e., the cup holder retaining element is within the cup holder. Optionally, in this lower horizontal element alone, the entire wire device, or less than the entire wire device but more than the lower horizontal elements alone may be coated with plastic, rubber or a combination thereof. This cup holder retaining element is resiliently compressible, thereby allowing it to push outward against the walls of the cup holder.

Within a connector region, bends in the wire rest on the lip of the cup holder and provide a cradle 361 and 362 for the cellular telephone. Still within the connector region, the wires that emanate from the left cradle region 361 and the right cradle region 362 cross and lead into the right side grip and the left side grip 321 and 322. The side grips hold the cellular telephone by clamping inwards and have a range that allows the device to accommodate a range of portable electronic devices. As shown in the figure, the wire device leaves the location of the port on most cellular telephones for charging and/or docking 395 and the location for push buttons 398 accessible. The wires of the wire device cross again after leaving the right side grip and the left side grip on the way to a coil 396.

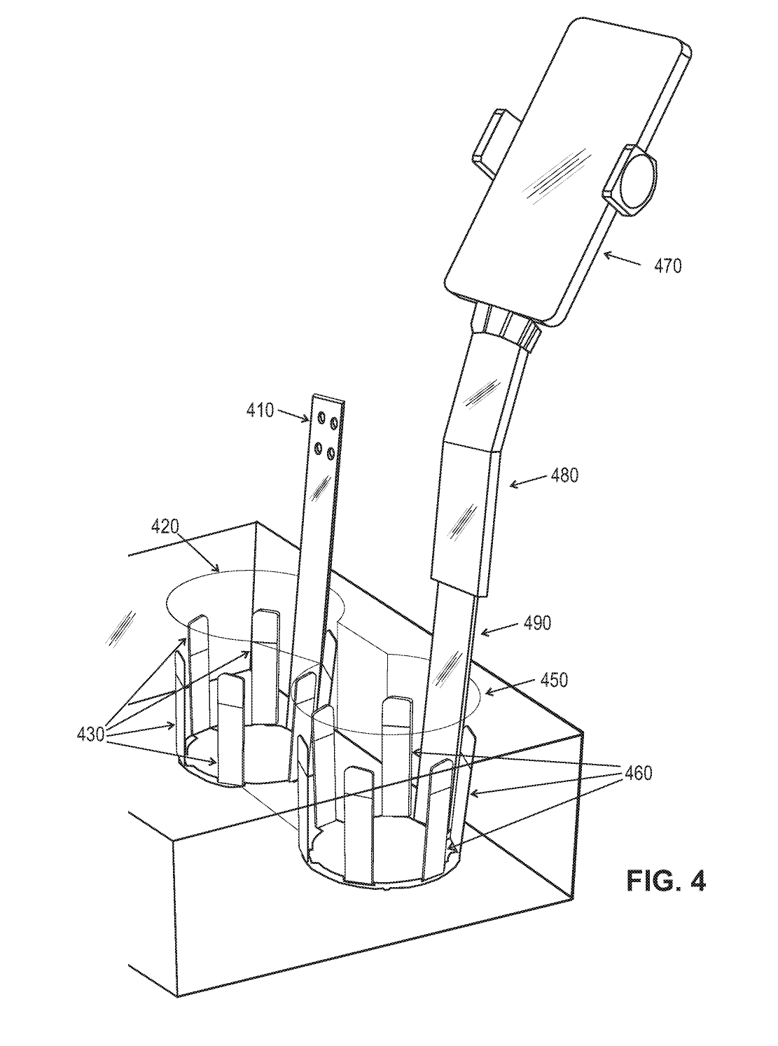

FIG. 4 is an illustration of two leaf spring designs of the present invention. The left design shows a portion of an apparatus within and an adapter a cup holder 420. There is a plurality of side retaining elements 430 in their second state. Also shown is an elongated element 410, which extends beyond the rim of the cup holder. For illustrative purposes, in this design no clamp for retaining the electronic device is shown. There are a number of already known types of clamps in the marketplace and the cup holder retaining element as shown could be associated with any number of them or other structures for retaining association with a personal electronic device, regardless of the structure contains a clamp and it is within the scope of the present invention for there to be an adapter equipped with a structure that allows for association with a plurality of different types of clamps or connectors that are associated with clamps. Examples of configurations of adapters that may become associated with a plurality of different types of connectors and/or clamps include but are not limited to threads (for example, male or female screw thread with the connector or clamp having the reciprocal elements) or one or more holes (with the connector or clamp having the reciprocal element of one or more pins), or one or more pins (with the connector or clamp having the reciprocal element of one or more holes) or one or more slots or depressions (with the connector or clamp having the reciprocal element of one or more male projects) or one or more projections (with the connector or clamp having the reciprocal element of one or more female slots or depressions) or a combination thereof.

The apparatus in the right of FIG. 4 shows a different leaf spring design. As shown, there is a plurality of side retaining elements 460 within a cup holder 450. There is also an elongated element 490, which may be shorter than the elongated element of the left apparatus or the same size but partially covered. Here there is a connector 480 and a clamp device 470.

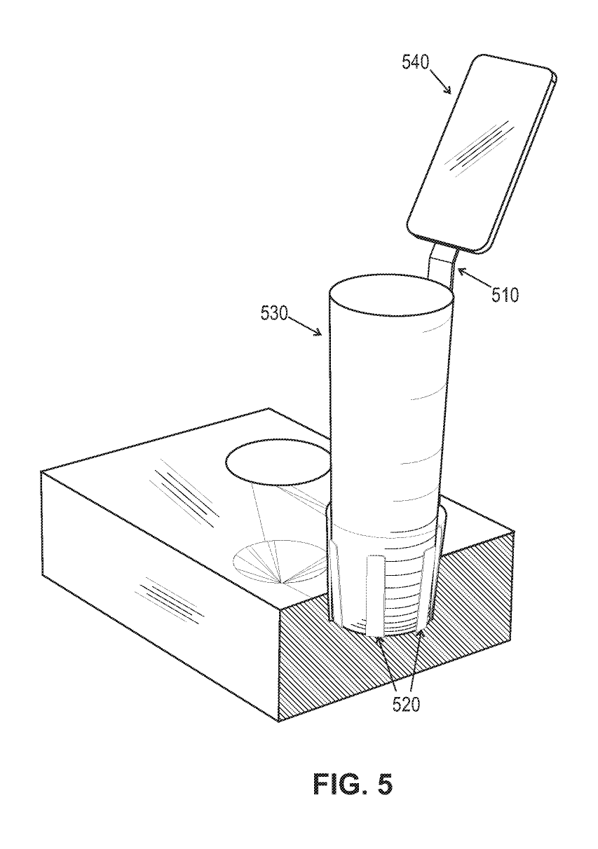

FIG. 5 shows a rendering of an apparatus similar to the right apparatus in FIG. 4, in which there is a slate for a personal electronic device 540 and a cup 530. For reference, side bracing elements 520 and the elongated element 510 are shown and to illustrate the second state, the device is shown with a section of the cup holder removed. A clamp for holding the portable electronic device on the slate is not shown and need not be present if there is another means for holding the portable electronic device on the slate, e.g., one or more clips and/or magnets.

Any of the features of the various embodiments described herein can be used in conjunction with features described in connection with any other embodiments disclosed unless otherwise specified. Thus, features described in connection with the various or specific embodiments are not to be construed as not suitable in connection with other embodiments disclosed herein unless such exclusivity is explicitly stated or implicit from context.

1. An apparatus for associating a portable electronic device with a cup holder, wherein the apparatus comprises:
(a) a clamp, wherein the clamp is configured to retain association with a portable electronic device;
(b) a cup holder retaining element, wherein the cup holder retaining element comprise a base and a plurality of side bracing elements, wherein each of the plurality of side bracing elements is capable of existing in a first state and a second state, wherein in the first state each side bracing element forms a first angle with the base and in the second state each side bracing element forms a second angle with the base, wherein the second angle is at least 90 degrees, the second angle is smaller than the first angle, and first angle is up to 180; and
(c) an elongated element, wherein the clamp is connected to the cup holder retaining element through the elongated element, wherein the elongated element is connected to the base of the cup holder retaining element and wherein when the side bracing elements are in the first state, the elongated element has an angle of 100 degrees to 140 degrees relative to the base, and when the side bracing elements are in the second state the elongated element has an angle of 90 degrees to 120 degrees relative to the base.

2. The apparatus of claim 1, wherein the base is circular.

3. The apparatus of claim 2, wherein there are 3-10 side bracing elements.

4. The apparatus of claim 3, wherein the clamp comprises a slate on which a portable electronic device may rest.

5. The apparatus of claim 1, wherein the side bracing elements are made from a resiliently deformable material that upon the exertion or removal of force are capable of reversibly moving between the first state and the second state.

6. The apparatus of claim 2, wherein the elongated element and the cup holder retaining element form a leaf spring design.

7-49. (canceled)

50. An apparatus for associating a portable electronic device with a cup holder, wherein the apparatus comprises:
1. a cup holder retaining element, wherein the cup holder retaining element comprise a base and 3-10 side bracing elements, wherein each of the plurality of side bracing elements is capable of existing in a first state and a second state, wherein in the first state each side bracing element forms a first angle with the base and in the second state each side bracing element forms a second angle with the base, wherein the second angle is at least 90 degrees, the second angle is smaller than the first angle, and first angle is up to 180, and
2. an elongated element, wherein the elongated element comprises an adapter, wherein the adapter is configured to associate with a connector or a clamp and the elongated element is connected to the base of the cup holder retaining element.

51. The apparatus of claim 50, wherein the elongated element is longer than all of the side bracing elements.

52. The apparatus of claim 51 further comprising a clamp, wherein the clamp is configured to exert a mechanical force on a portable electronic device and the clamp comprises a slate on which the portable electronic device may rest.

53. The apparatus of claim 52, wherein the side bracing elements are made from a resiliently deformable material that upon the exertion or removal of force are capable of reversibly moving between the first state and the second state.

54. The apparatus of any of claim 50, wherein the adapter comprises screw threads.

55. The apparatus of any of claim 50, wherein the adapter comprises one or more holes for receiving at least one pin from a connector.
